(19) United States
(12) Patent Application Publication
(10) Pub. No.: US 2002/0076301 A1
(43) Pub. Date: Jun. 20, 2002

(54) Rivet

(76) Inventor: Wen-Hsiung Yang, Changhua City (TW)

Correspondence Address: CONNOLLY BOVE LODGE & HUTZ, LLP, 1220 N MARKET STREET, P O BOX 2207, WILMINGTON, DE, 19899

(21) Appl. No.: 09/736,768

(22) Filed: Dec. 14, 2000

(51) Int. Cl. F16B 21/00

(52) U.S. Cl. 411/339

(57) ABSTRACT

A rivet comprises an elongated male rivet part, and an elongated female rivet part. The male rivet part provides an elongated engaging post. The elongated female rivet part provides an elongated engaging post with an elongated inner bore for fitting with the engaging post on the male rivet part by way of pressing. A work piece such as a handle provides an elongated counter bore to be passed through by the female rivet part such that the work piece and another work piece can be fastened together by the rivet firmly.

### BACKGROUND OF THE INVENTION

1. Field of the Invention

The present invention relates to a rivet, particularly to an improvement of post part on a rivet for fastening work pieces together without slipping to other.

2. Description of Related Art

A conventional rivet usually has male rivet part 13 and a female rivet part 15. Both rivet parts 13, 15 are provided with a cylindrical engaging post 14, 16 as shown in FIG. 1. As illustrated in FIG. 1, a knife 10 has a handle 18 and the handle 18 composed of two cover plates 11 to join the rear end part of the knife 10. Each cover plate 11 has two counter bores 12 for locating two conventional rivets. The cylindrical engaging post 18 on the respective female rivet 15 has an inner circular hole 17 for fitting with the cylindrical engaging post 14 on the respective male rivet part 13 tightly. In order to fasten the handle 18 to the rear end part of the knife 10, the respective female rivet part 15 is inserted into the respective counter bore 12 from a lateral side of one of the cover plates 11. The engaging post 14 of the respective male rivet part 13 fits with the inner hole 17 tightly by way of pressing. The preceding conventional rivet has following disadvantages:

1. The cylindrical engaging posts arranged on the rivet may result in a rotational movement of the rivet.

2. In order to prevent the joined work pieces from slipping to each other as soon as these work pieces have been fastened, at least two rivets have to be used for the fastening job.

Referring to FIG. 2, another conventional rivet is illustrated to have different shapes of rivet head such as a square head 23, a diamond head 25, and other irregular shapes of rivet head (not shown). Cylindrical engaging posts 24, 26 are press-fitted at holes 27, 28 with counter sinks 21, 22 corresponding to rivet heads 23, 25 such that cover plates 29 of the handle 20 may not slip to each other. In addition, each rivet head can be arranged a variety of shapes as desired to enhance a sense of beauty for the handle 20 used on a knife, a pan, a leather article, a decoration, and etc. However, the prior art still has following disadvantages:

The rivet head 23, 25 are easy to misalign with counter sinks 21, 22 while the rivets are pressed to engage with the handle. Hence, it is frequent to result in a damaged handle.

By the same token, a defect product of leather article, decoration, and etc may result in because of the male rivet and the female rivet part being not easy to align with each other.

### SUMMARY OF THE INVENTION

A rivet according to the present invention resides in that the engaging post on the rivet is designed to have a cross section of non-circular shape. Thus, work pieces can be joined together firmly by only one rivet and the phenomenon resulting from joined work pieces slipping to each other may be avoidable.

An object of the present invention is to provide a rivet, which is possible to fasten work pieces together firmly alone.

Another object of the present invention is to provide a rivet, which is possible to keep from angular movement after fastening.

A further object of the present invention is to provide a rivet having a variety of outline shapes so a to allow a male rivet part and a female rivet part matching with each other perfectly.

A still further object of the present invention is to provide a rivet, which is suitable for not only fastening handle on a knife, a pan, and etc but also engaging with personal product such as clothes, a decoration, and etc for enhancing a sense of beauty.

### BRIEF DESCRIPTION OF THE DRAWINGS

The present invention can be more fully understood in the following description with reference to accompanying drawings, in which:

FIG. 1 is a disassembled perspective view illustrating a prior art of rivet used for fastening a knife handle;

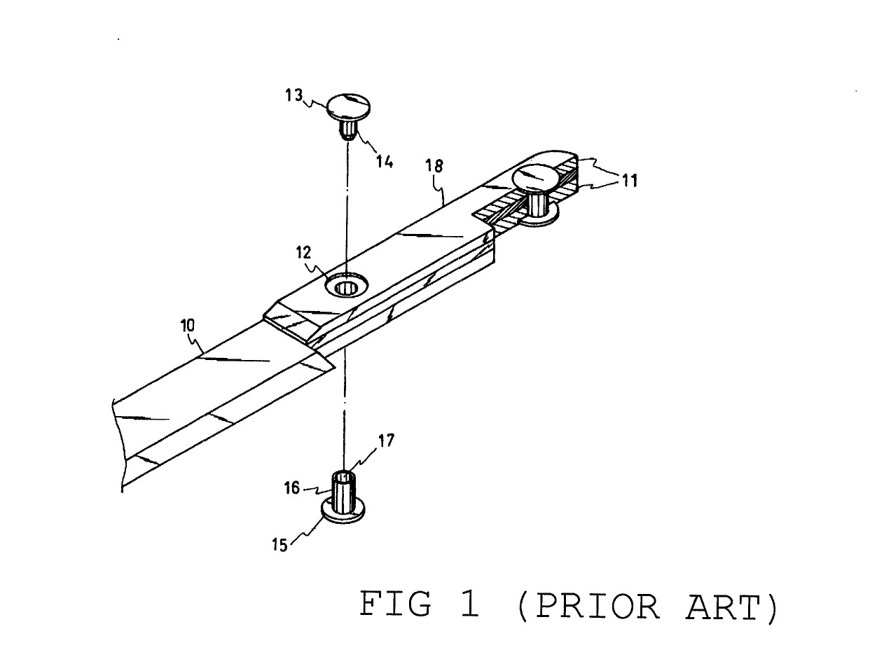

FIG. 2 is a disassembled perspective view of a prior art of another type of rivet for fastening a knife handle;

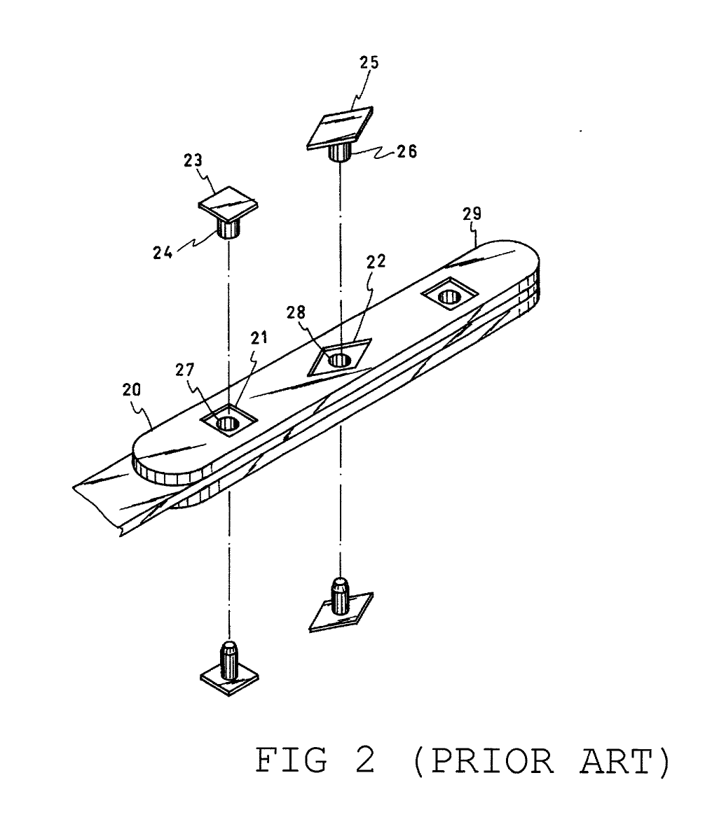

FIG. 3 is a perspective view of a preferred embodiment rivet according to the present invention;

FIG. 4 is a perspective view of anther preferred embodiment according to the present invention;

FIG. 5 is a perspective view similar to FIG. 4;

FIG. 6 is a perspective view of a still further preferred embodiment according to the present invention; and

FIG. 7 is a perspective view of a still further preferred embodiment according to the present invention.

### DETAILED DESCRIPTION OF THE PREFERRED EMBODIMENTS

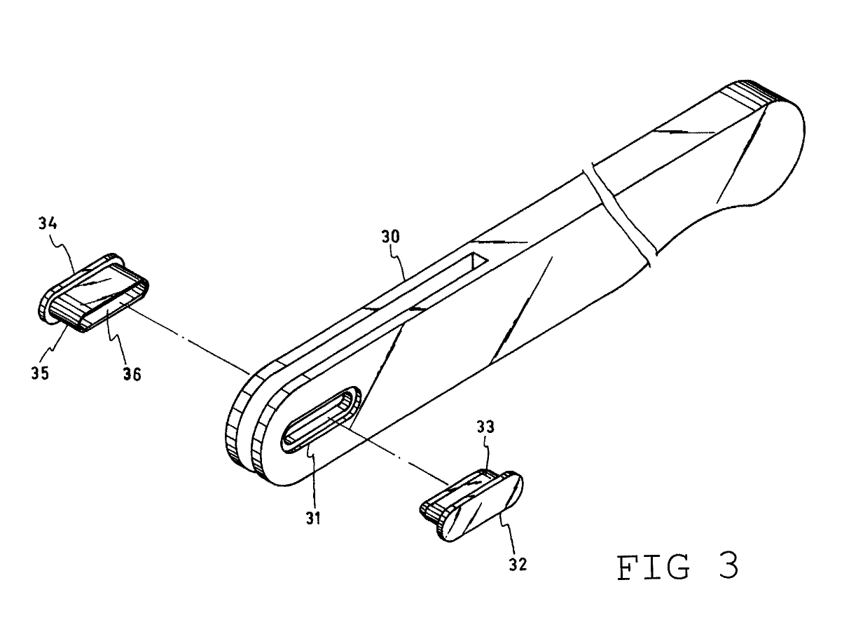

Referring to FIG. 3, a first preferred embodiment of the present invention comprises a male elongated rivet part 32 and a female elongated rivet part 34 instead of the conventional male and female rivet parts. A work piece such as a handle 30 provides a counter elongated bore 31 having the same shape as the elongated parts 32, 34. The female elongated rivet part 34 has an elongated engaging post 35 with an elongated inner hole 36 and the male elongated rivet part 32 has an elongated engaging post 33. The engaging post 33 is inserted into the elongated hole 36 to engage with the engaging post 35 in a way of press fit. When another work piece is placed in the work piece 30 for joining together, the engaging post 35 of the female elongated rivet part 34 is disposed in the elongated counter bore 31 from a lateral side of the work piece 32. Thus, the engaging post 33 can be press-fitted in the elongated hole 36 of the post 35 to fasten these two work pieces tightly without occurring any slip to each other. It is noted that the preceding rivet can fasten the work pieces together firmly instead of two conventional rivets performing the same function.

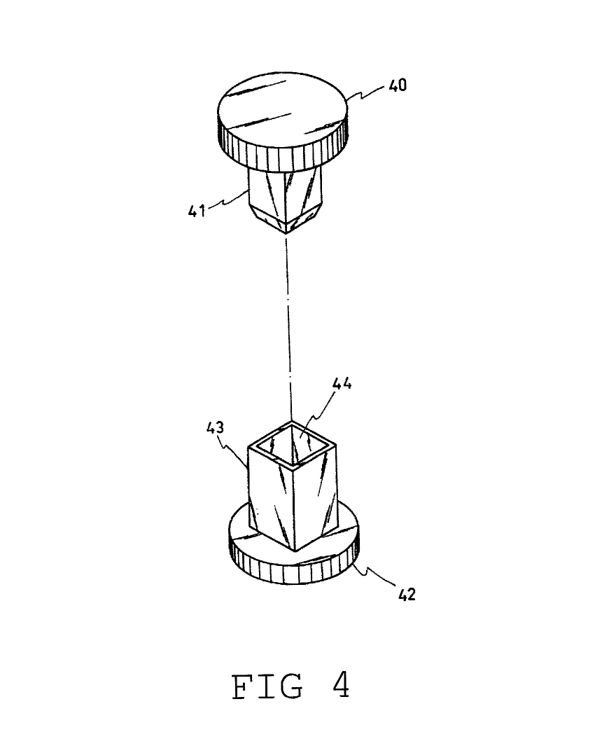

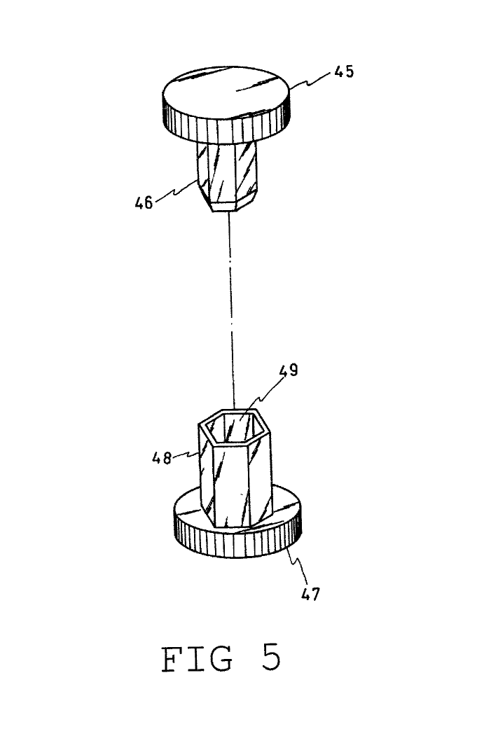

Referring to FIGS. 4 and 5, a second preferred embodiment is illustrated. As shown in FIG. 4, the male rivet part 40 provides a rectangular or square post 41 to fit with the rectangular or square post 43 provided on the female rivet part 42 by way of pressing. As shown in FIG. 5, the male rivet part 45 has a polygon post 46 to fit with a polygon hole 49 in the polygon post 48 provided on the female rivet part 47 by way of pressing. In addition to fasten work pieces together, the rivet set in the second preferred embodiment also can keep the rivet itself without angular movement.

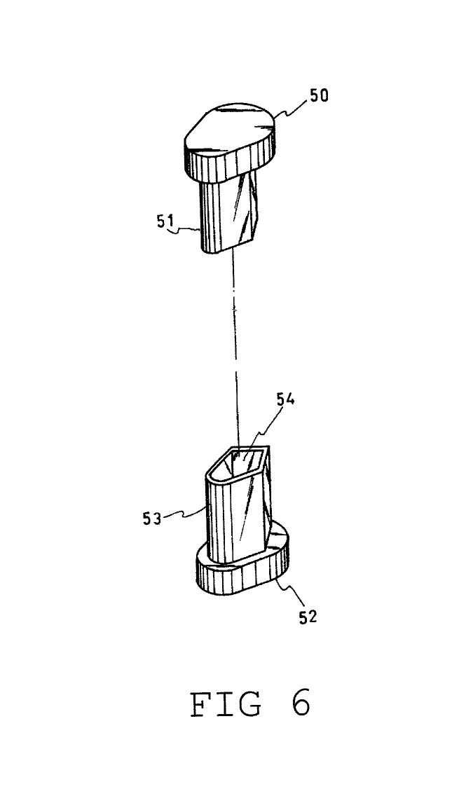

Referring to FIG. 6, a third preferred embodiment is illustrated. In order to assure the rivet without angular movement after fastening, the post 51 on the male rivet part 50 and the post 53 on the female rivet part 52 can be arranged to have an irregular shape of cross section. Once the post 51 fits with the irregular shape of hole 54 in the post 53, an angular movement of the rivet may be restricted completely.

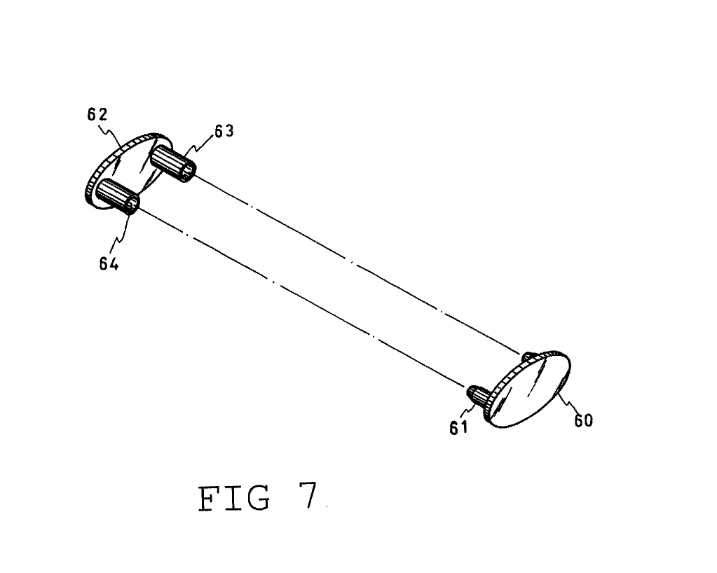

Referring to FIG. 7, a fourth preferred embodiment is illustrated. The male rivet part 60 provides two posts 61 and the female rivet part 62 provides two posts 63 corresponding to these two posts 61. The posts 63 have a hole 64 respectively for fitting with the posts 61. The rivet provided in the fourth preferred embodiment can assure work pieces being fastened firmly without slip to each other and may resist the rivet to generate any angular movement.

It is appreciated that the rivet of the present invention not only can fasten at least two work pieces together but also can keep itself from angular movement. Furthermore, a single rivet of the present invention can fasten work pieces tightly instead of being done by two conventional rivets.

While the invention has been described with reference to a preferred embodiment, it is to be understood that modifications and variations may be easily made without departing from the spirit of this invention defined by the appended claim.

1. A rivet, comprising
an elongated male rivet part, providing a first elongated engaging post, and
an elongated female rivet part, providing a second elongated engaging post with an elongated inner bore for fitting with the first engaging post by way of pressing;
whereby, a work piece such as a handle provided with an elongated counter bore can be passed through by the female rivet part such that the work piece and another work piece can be fastened together by the rivet firmly.

2. The rivet as defined in claim 1, wherein the first and the second elongated engaging posts have a cross section of polygon.

3. The rivet as defined in claim 1, wherein the first and the second elongated engaging posts have a cross section of irregular shape.

4. The rivet as defined in claim 1, wherein the first and the second elongated engaging posts have a cross section of rectangle or square.

5. A rivet, comprising
an elongated male rivet part, providing at least two
elongated engaging posts, and
an elongated female rivet part, providing at least two elongated hollow engaging posts for fitting with said two engaging post by way of pressing;
whereby, a work piece such as a handle provided with at least two elongated counter bores can be passed through by the female rivet part such that the work piece and another work piece can be fastened together by the rivet firmly.

6. The rivet as defined in claim 1, wherein each of said elongated engaging posts has a cross section of polygon.

7. The rivet as defined in claim 1, wherein each of said elongated engaging posts has a cross section of irregular shape.

8. The rivet as defined in claim 1, wherein each of said elongated engaging posts has a cross section of rectangle or square.
